(19) United States
(12) Patent Application Publication
(10) Pub. No.: US 2014/0301108 A1
(43) Pub. Date: Oct. 9, 2014

(54) ILLUMINATING UNIT, DISPLAY UNIT, AND ELECTRONIC APPARATUS

(71) Applicant: Sony Corporation, Tokyo (JP)

(72) Inventors: Toshikatsu Mineura, Aichi (JP); Akira Watanabe, Gifu (JP); Ichido Ikeda, Aichi (JP)

(73) Assignee: Sony Corporation, Tokyo (JP)

(21) Appl. No.: 14/354,955

(22) PCT Filed: Oct. 12, 2012
(86) PCT No.: PCT/JP2012/076521

§ 371 Date: Apr. 29, 2014

(30) Foreign Application Priority Data
Nov. 8, 2011 (JP) 2011-244826

(51) Int. Cl. F21V 8/00

(52) U.S. Cl. CPC G02B 6/0011
USPC 362/615

(57) ABSTRACT

Provided is a display unit capable of achieving a more excellent image. The display unit includes an illuminating unit and a display section configured to perform image display using light from the illuminating unit. The illuminating unit includes a light guide plate extending in a plane that includes a first direction and a second direction intersecting with each other, a substrate supporting the light guide plate, and first and second support sections provided in part of the light guide plate and part of the substrate. The first support section allows displacement of the light guide plate in the second direction while limiting displacement of the light guide plate in the first direction. The second support section allows displacement of the light guide plate in the first direction while limiting displacement of the light guide plate in the second direction.

### TECHNICAL FIELD

The present disclosure relates to a display unit, an electronic apparatus including the display unit, and an illuminating unit that is to be mounted in the display unit.

### BACKGROUND ART

Examples of known display units in recent years include self-luminous display units such as a plasma display and an organic EL display, and non-light-emitting display units such as a liquid crystal display. Among them, the liquid crystal display includes, for example, a transmissive liquid crystal panel as a light modulation device, and a backlight system configured to apply illumination light to the liquid crystal panel. The liquid crystal panel is configured to display a predetermined image through control of a transmittance of the illumination light from the backlight system.

In recent years, a thin display unit has been increasingly demanded. Therefore, there has been proposed a structure where a light guide plate is disposed at the back (on a side opposite to a display surface) of the liquid crystal panel, and a light source of the backlight system is disposed so as to be opposed to an end face of the light guide plate (for example, see Patent Documents 1 and 2).

However, when a distance between the light source and the light guide plate is excessively small, the light guide plate may have been expanded or distorted due to heat generated during light emission of the light source. To solve such a problem, for example, a structure described in Patent Document 3 has been proposed.

### PRIOR ART DOCUMENT

### Patent Document

Patent Document 1: JP 2009-110811A
Patent Document 2: JP 2009-32664A
Patent Document 3: JP 2011-150264A

### SUMMARY OF THE INVENTION

In the structure described in Patent Document 3, however, the light guide plate as a whole is moved with respect to the liquid crystal panel due to expansion of the light guide plate. Specifically, a relative position in an in-plane direction between the light guide plate and the liquid crystal panel is shifted due to thermal expansion of the light guide plate. For example, when a display unit displays a stereoscopic image, such a shift in relative position causes a problem of degradation in display performance of the display unit. This is because a relative position between a display pixel and a parallax barrier of the liquid crystal panel is desirably maintained at high accuracy in stereoscopic image display, and in some cases, the light guide plate is estimated to further serve as the parallax barrier. Although an approach of bonding the light guide plate to the liquid crystal panel is likely to be taken, when the two have different constitutional materials, unnecessary stress may be generated at a bonding plane due to different thermal expansion coefficients, leading to a warp or distortion of the light guide plate or the liquid crystal panel. As a result, image degradation occurs. In particular, such a problem markedly occurs in a display unit having large display area.

Consequently, it is desirable to provide a display unit capable of forming an excellent stereoscopic image despite a thin and simple configuration, an electronic apparatus including the display unit, and an illuminating unit that is to be preferably mounted in the display unit.

According to an embodiment of the present disclosure, there is provided an illuminating unit which is for a display unit, and includes: a light guide plate extending in a plane that includes a first direction and a second direction intersecting with each other; a substrate supporting the light guide plate; and first and second support sections provided in part of the light guide plate and part of the substrate. The first support section allows displacement of the light guide plate in the second direction while limiting displacement of the light guide plate in the first direction, and the second support section allows displacement of the light guide plate in the first direction while limiting displacement of the light guide plate in the second direction.

According to an embodiment of the present disclosure, there is provided a display unit provided with the above-described illuminating unit, and a display section configured to perform image display using light from the illuminating unit. According to an embodiment of the present disclosure, there is provided an electronic apparatus provided with the above-described display unit.

In the illuminating unit according to the embodiment of the present disclosure, the first support section and the second support section are provided. The first support section enables displacement of the light guide plate in the second direction while limiting displacement of the light guide plate in the first direction, and the second support section enables displacement of the light guide plate in the first direction while limiting displacement of the light guide plate in the second direction. Consequently, movement of the light guide plate as a whole from an initial position is suppressed even if the light guide plate is thermally expanded. A portion of the light guide plate, which is located on an extension (referred to as first extension for convenience) passing through the first support section in the second direction, is not movable in the first direction while being movable in the second direction. On the other hand, a portion of the light guide plate, which is located on an extension (referred to as second extension for convenience) passing through the second support section in the first direction, is not movable in the second direction while being movable in the first direction. As a result, no movement takes place in any direction at a position (central position) where the extension (first extension) passing through the first support section in the second direction intersects with the extension (second extension) passing through the second support section in the first direction. When the light guide plate is thermally expanded, the light guide plate is displaced in an outward spreading manner about the central portion at which the first extension intersects with the second extension. Conversely, when the light guide plate is cooled and contracted, the light guide plate is displaced in a converging manner to the central portion. In this way, the light guide plate behaves reversibly about the central portion thereof. At this time, displacement is smaller at a portion closer to the central position.

According to the illuminating unit of the embodiment of the present disclosure, displacement of the light guide plate is allowed to be reduced during thermal expansion thereof without hindering reduction in thickness. Consequently, according to the display unit and the electronic apparatus that each incorporate the illuminating unit, a relative position between the light guide plate and the display section is allowed to be relatively accurately maintained while achieving reduction in thickness. Hence, it is possible to form an excellent stereoscopic image despite being of a thin type.

### BRIEF DESCRIPTION OF THE DRAWINGS

FIG. 1 is a sectional diagram illustrating an exemplary configuration of a display unit according to a first embodiment of the present disclosure together with a state of light rays emitted from a light source device in the case where only first light sources stay on (lit).

FIG. 2 is a sectional diagram illustrating the exemplary configuration of the display unit illustrated in FIG. 1 together with a state of light rays emitted from the light source device in the case where only a second light source stays on (lit).

FIG. 3 is a sectional diagram illustrating the exemplary configuration of the display unit illustrated in FIG. 1 together with a state of light rays emitted from the light source device in the case where both the first and second light sources stay on (lit).

FIG. 4 includes a plan diagram and a sectional diagram, illustrating a relevant part of the exemplary configuration of the display unit illustrated in FIG. 1.

FIG. 5 includes a sectional diagram illustrating a first exemplary configuration of a surface of a light guide plate of the display unit illustrated in FIG. 1, and an explanatory diagram schematically illustrating light rays scatter-reflected at the surface of the light guide plate.

FIG. 6 includes a sectional diagram illustrating a second exemplary configuration of the surface of the light guide plate of the display unit illustrated in FIG. 1, and an explanatory diagram schematically illustrating light rays scatter-reflected at the surface of the light guide plate.

FIG. 7 includes a sectional diagram illustrating a third exemplary configuration of the surface of the light guide plate of the display unit illustrated in FIG. 1, and an explanatory diagram schematically illustrating light rays scatter-reflected at the surface of the light guide plate.

FIG. 8 is a plan diagram illustrating an example of a pixel structure of a display section.

FIG. 9 includes a plan diagram and a sectional diagram, illustrating a first example of a correspondence relationship between an assignment pattern in assignment of two perspective images and an arrangement pattern of the scattering regions in the pixel structure of FIG. 8.

FIG. 10 is a plan diagram illustrating a relevant part in an exemplary configuration of a display unit according to a second embodiment of the present disclosure.

FIG. 11 is a perspective diagram illustrating a configuration of a television unit as an electronic apparatus using the display unit.

FIG. 12 is a plan diagram illustrating a relevant part of another exemplary configuration (Modification 1) of the display unit illustrated in FIG. 1.

FIG. 13 is a plan diagram illustrating a relevant part of another exemplary configuration (Modification 2) of the display unit illustrated in FIG. 1.

FIG. 14 is a plan diagram illustrating a relevant part of another exemplary configuration (Modification 3) of the display unit illustrated in FIG. 1.

### MODE FOR CARRYING OUT THE INVENTION

Hereinafter, embodiments of the present disclosure will be described in detail with reference to the accompanying drawings.

### First Embodiment

[Overall Configuration of Display Unit]

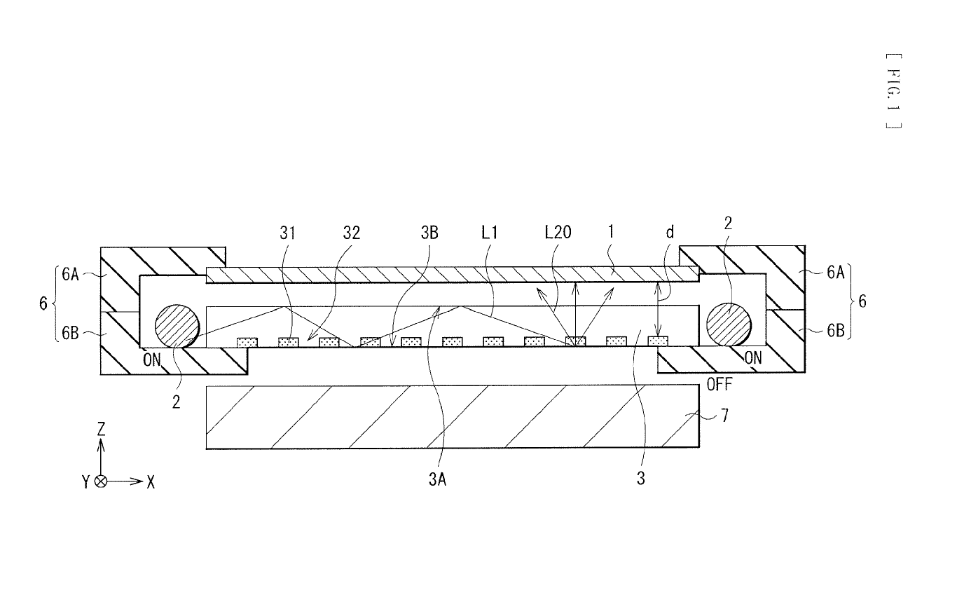

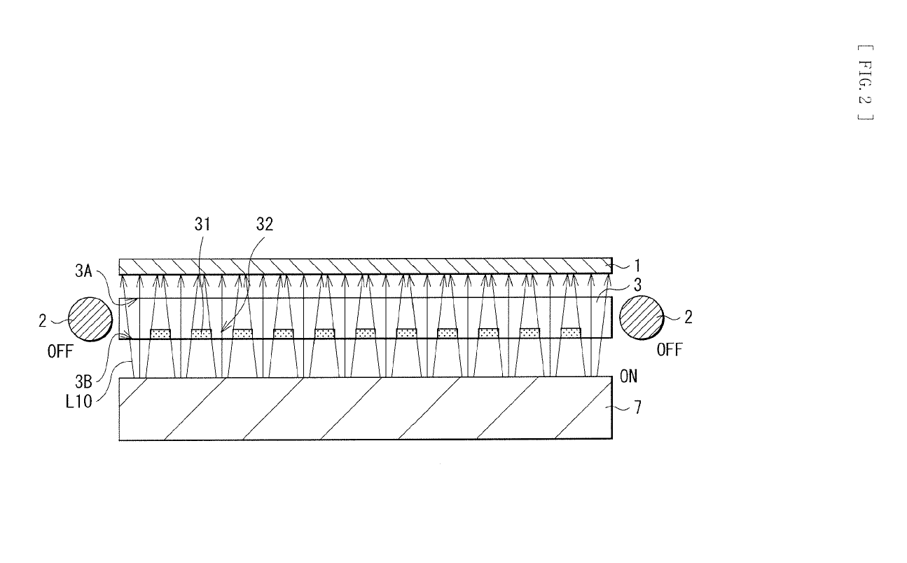

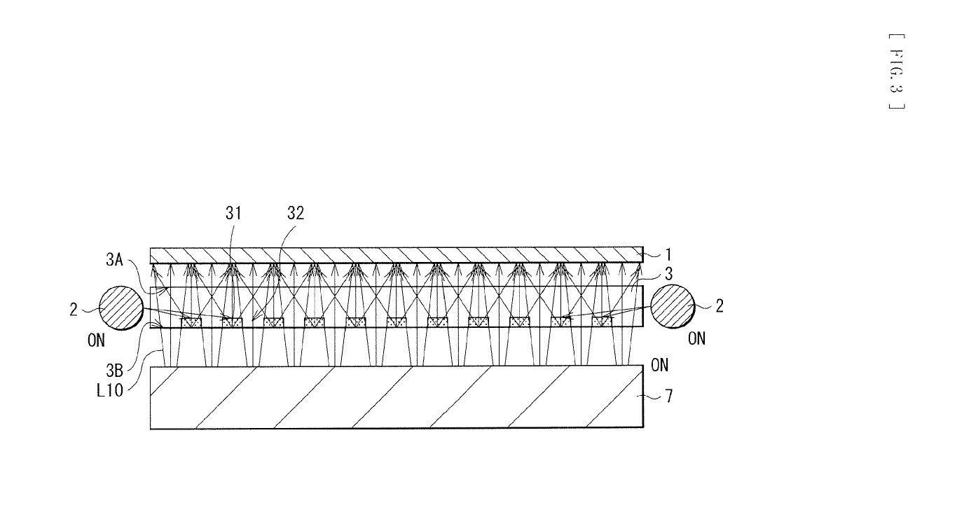

FIGS. 1 to 3 illustrate an exemplary configuration of a display unit according to a first embodiment of the present disclosure. The display unit includes a display section 1 configured to perform image display, and an illuminating unit disposed on a back side of the display section 1 and configured to emit light for image display to the display section 1. The illuminating unit includes first light sources 2 (light sources for 2D/3D display), a light guide plate 3, and a second light source 7 (a light source for 2D display). The light guide plate 3 includes a first internal reflection face 3A disposed to be opposed to the display section 1, and a second internal reflection face 3B disposed to be opposed to the second light source 7. The display section 1 and the light guide plate 3 are held by a holding frame 6 so as to be opposed to each other (FIG. 1). The holding frame 6 is configured of a first frame 6A that is to hold the display section 1 and a second frame 6B that is to hold the light guide plate 3, the first and second frames 6A and 6B being bonded to each other by undepicted screws or the like. The light guide plate 3 is supported by the second frame 6B with two types of support sections (first and second support sections 61 and 62 described later) provided in part of the light guide plate 3 and part of the second frame 6B. The second frame 6B is also a component of the illuminating unit. In FIGS. 2 and 3, illustration of the holding frame 6 is omitted. Although the display section 1 and the light guide plate 3 are disposed to be opposed to each other, they are not bonded together by an adhesive or the like. Consequently, a small space is formed between the display section 1 and the light guide plate 3. In FIG. 1, however, thickness (i.e., a gap between the display section 1 and the light guide plate 3) of the space is shown relatively large with respect to thickness of each of the display section 1 and the light guide plate 3 in order to describe a path of a light ray. In addition, the display unit includes a control circuit, etc. configured to control the display section 1 to be used for display. Since a configuration of the control circuit, etc. is similar to that of a typical control circuit, etc. for display, description of that is omitted. The light source device further includes an undepicted control circuit configured to control each of the first light sources 2 and the second light source 7 to be on (lit) or off (unlit).

In this display unit, a full-screen two-dimensional (2D) display mode and a full-screen three-dimensional (3D) display mode are allowed to be selectively switched on an optional basis. Such switching between the two-dimensional display mode and the three-dimensional display mode is enabled through switching control of image data displayed on the display section 1 and on/off switching control of each of the first light source 2 and the second light source 7. FIG. 1 schematically illustrates a state of light rays emitted from the light source device in the case where only the first light sources 2 stay on (lit), which corresponds to the three-dimensional display mode. FIG. 2 schematically illustrates a state of light rays emitted from the light source device in the case where only the second light source 7 stays on (lit), which corresponds to the two-dimensional display mode. FIG. 3 schematically illustrates a state of light rays emitted from the light source device in the case where both the first and second light sources 2 and 7 stay on (lit), which also corresponds to the two-dimensional display mode.

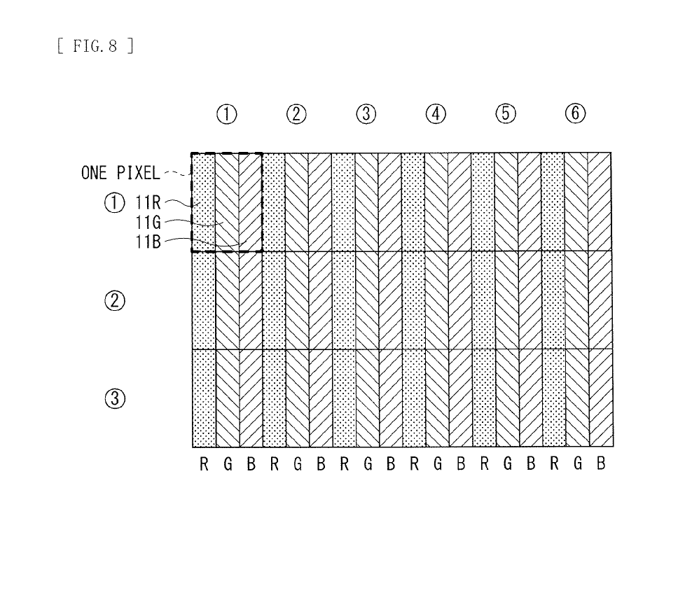

The display section 1 is configured of a transmissive two-dimensional display panel, for example, a transmissive liquid crystal display panel, and may include a plurality of pixels arranged in a matrix, each pixel including a R (red) display pixel 11R, a G (green) display pixel 11G, and a B (blue) display pixel 11B as illustrated in FIG. 8, for example. The display section 1 allows light from the light source device to be modulated on a pixel basis in accordance with image data, and thus performs two-dimensional image display. The display section 1 displays a plurality of perspective images based on three-dimensional image data and an image based on two-dimensional image data in a selectively switchable manner on an optional basis. It is to be noted that the three-dimensional image data may refer to, for example, data including a plurality of perspective images corresponding to a plurality of viewing angle directions in three-dimensional display. For example, in two-eye-type three-dimensional display, the three-dimensional image data may correspond to perspective image data for right-eye display and for left-eye display. For example, a composite image configured of a plurality of perspective images arranged in a stripe form in one screen may be formed and displayed for display in the three-dimensional display mode. It is to be noted that an exemplary correspondence relationship between an assignment pattern of a plurality of perspective images to each pixel of the display section 1 and an arrangement pattern of scattering regions 31 is specifically described in detail later.

For example, each first light source 2 may be configured of a fluorescent lamp such as CCFL (Cold Cathode Fluorescent Lamp) or LED (Light Emitting Diode). The first light source 2 is configured to apply first illumination light L1 (FIG. 1) into the light guide plate 3 from a side face of the light guide plate 3. One or more first light sources 2 is disposed on a side face of the light guide plate 3. For example, when the light guide plate 3 has a rectangular planar shape, four side faces are provided. In this case, one or more first light source 2 may be disposed on one or more of the side faces. FIG. 1 illustrates an exemplary configuration where the first light sources 2 are disposed on two opposed side faces of the light guide plate 3. Each of the first light sources 2 is controlled to be on (lit) or off (unlit) in response to switching modes between the two-dimensional display mode and the three-dimensional display mode. In detail, the first light source 2 is controlled to stay lit for image display on the display section 1 based on the three-dimensional image data (in the case of three-dimensional display mode), and controlled to stay unlit or lit for image display on the display section 1 based on the two-dimensional image data (in the case of two-dimensional display mode).

The second light source 7 is disposed to be opposed to the second internal reflection face 3B of the light guide plate 3. The second light source 7 is configured to externally apply second illumination light L10 to the second internal reflection face 3B (see FIGS. 2 and 3). Any planar light source that emits light having uniform in-plane luminance, such as a commercially available planar backlight, may be used as the second light source 7 without any structural limitation. For example, a structure may be contemplated in which a light emitting body such as CCFL or LED and a light diffuser plate allowing uniform in-plane luminance are used. The second light source 7 is controlled to be on (lit) or off (unlit) in response to switching modes between the two-dimensional display mode and the three-dimensional display mode. In detail, the second light source 7 is controlled to stay unlit for image display on the display section 1 based on the three-dimensional image data (in the case of three-dimensional display mode), and controlled to stay lit for image display on the display section 1 based on the two-dimensional image data (in the case of two-dimensional display mode).

The light guide plate 3 is configured of a transparent plastic plate including, for example, acrylic resin. The surfaces other than the second internal reflection face 3B of the light guide plate 3 are entirely transparent. For example, when the light guide plate 3 has a rectangular planar shape, the first internal reflection face 3A and the four side faces are entirely transparent.

The first internal reflection face 3A is entirely mirror-finished, and internally and totally reflects light rays incident at an angle that satisfies a total reflection condition inside the light guide plate 3, and emits light rays that do not satisfy the total reflection condition to the outside.

The second internal reflection face 3B has the scattering regions 31 and total reflection regions 32. The scattering regions 31 are each formed on a surface of the light guide plate 3 through laser processing, sandblasting processing, coating processing, or attachment of a sheet-like light-scattering component, as described below. On the second internal reflection face 3B, the scattering regions 31 function as the openings (slit sections) of a parallax barrier for the first illumination light L1 from the first light source 2, and the total reflection regions 32 function as the light-shielding sections of the parallax barrier, during the three-dimensional display mode. On the second internal reflection face 3B, the scattering regions 31 and the total reflection regions 32 are provided in a pattern defining a structure corresponding to the parallax barrier. Specifically, the total reflection regions 32 are provided in a pattern corresponding to the light-shielding sections of the parallax barrier, and the scattering regions 31 are provided in a pattern corresponding to the openings thereof. It is to be noted that a barrier pattern of the parallax barrier may include various types of patterns without particular limitation, for example, a stripe-shaped pattern where a large number of vertically-elongated slit-like openings are horizontally arranged side-by-side with the light-shielding section therebetween.

The first internal reflection face 3A and the total reflection regions 32 of the second internal reflection face 3B internally totally reflect light rays incident at an angle θ1 that satisfies the total reflection condition (internally totally reflect light rays incident at an angle θ1 larger than a predetermined critical angle α). As a result, the first illumination light L1 from the first light source 2, the light L1 being incident at the angle θ1 that satisfies the total reflection condition, is laterally guided through internal total reflection between the first internal reflection face 3A and the total reflection regions 32 of the second internal reflection face 3B. The total reflection regions 32 transmit the second illumination light L10 from the second light source 7 and emits the transmitted light, as light rays that do not satisfy the total reflection condition, to the first internal reflection face 3A, as illustrated in FIG. 2 or 3.

When the refractive index of the light guide plate 3 is denoted as n1, and the refractive index of a medium (an air layer) outside the light guide plate 3 is denoted as n0 (<n1), the critical angle α is represented as follows. Each of the angles α and θ1 is defined as an angle with respect to a normal to a surface of the light guide plate. The incident angle θ1 that satisfies the total reflection condition is larger than the critical angle α. sin α=n0/n1.

As shown in FIG. 1, the scattering regions 31 scatter-reflect the first illumination light L1 from the first light source 2, and emit at least of the first illumination light L1 to the first internal reflection face 3A as light rays (scattered light rays L20) that do not satisfy the total reflection condition.

[Exemplary Structure Supporting Light Guide Plate 3]

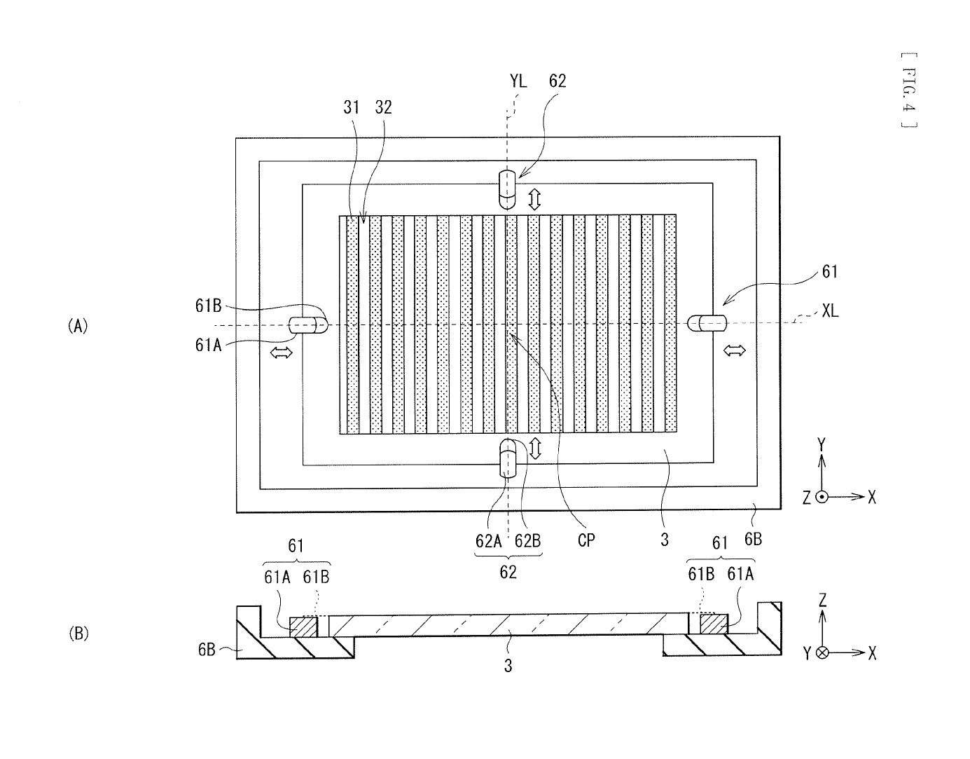

An exemplary structure of the second frame 6B supporting the light guide plate 3 is now described with reference to FIGS. 4(A) and 4(B). FIG. 4(A) is a plan diagram illustrating the illuminating unit of the display unit according to the present embodiment, showing a positional relationship between the second frame 6B and the light guide plate 3. FIG. 4(B) illustrates a cross section along a straight line XL illustrated in FIG. 4(A). In FIGS. 4(A) and 4(B), illustration of the first light sources 2 and the second light source 7 is omitted. The light guide plate 3 is supported by the second frame 6B with the first and second support sections 61 and 62.

As illustrated in FIG. 4(A), for example, two first support sections 61 and two second support sections 62 may be provided, any of which is located in a circumferential portion of the light guide plate 3. For example, a pair of first support sections 61 may allow displacement of the light guide plate 3 in an X-axis direction (second direction) corresponding to a screen horizontal direction while limiting displacement of the light guide plate 3 in a Y-axis direction (first direction) corresponding to a screen vertical direction. On the other hand, a pair of second support sections 62 may allow displacement of the light guide plate 3 in the Y-axis direction while limiting displacement of the light guide plate 3 in the X-axis direction. The pair of first support sections 61 are disposed on the same straight line XL extending in the X-axis direction, while the pair of second support sections 62 are disposed on the same straight line YL extending in the Y-axis direction. For example, the first support sections 61 may be disposed at a central position of the light guide plate 3 in the Y-axis direction, while the second support sections 62 may be disposed at a central position of the light guide plate 3 in the X-axis direction.

For example, the respective first and second support sections 61 and 62 may have projections 61A and 62A that may be vertically and fixedly provided on the second frame 6B, and may have guide sections 61B and 62B that are provided on the light guide plate 3 and guide the projections 61A and 62A in the X-axis and Y-axis directions, respectively. For example, the guide sections 61B of the first support section 61 may be each formed as a notch extending in the X-axis direction, while the guide sections 62B of the second support section 62 may be each formed as a notch extending in the Y-axis direction. The projections 61A and 62A are engaged with the notches as the guide sections 61B and 62B, respectively. In the first support section 61, while a dimension of the projection 61A is substantially equal to a dimension of the guide section 61B in the Y-axis direction, a dimension of the guide section 61B is sufficiently larger than a dimension of the projection 61A in the X-axis direction. Specifically, an outer surface of the projection 61A and an inner surface of the guide section 61B stay in contact with each other in the Y-axis direction, while having some play therebetween in the X-axis direction. On the other hand, in the second support section 62, while a dimension of the projection 62A is substantially equal to a dimension of the guide section 62B in the X-axis direction, a dimension of the guide section 61B in the Y-axis direction is sufficiently larger than a dimension of the projection 61A in the Y-axis direction. Specifically, an outer surface of the projection 61A and an inner surface of the guide section 61B stay in contact with each other in the X-axis direction, while having some play therebetween in the Y-axis direction.

As a result of such a structure, for example, when the light guide plate 3 may be heated and cooled and thereby expanded and contracted, each portion of the light guide plate 3 may be displaced with respect to a position (central position) CP at which the straight line XL intersects with the straight line YL. Specifically, a portion of the light guide plate 3 located on the straight line XL is displaced in the X-axis direction, but does not substantially displace in the Y-axis direction due to existence of the first support section 61. On the other hand, a portion of the light guide plate 3 located on the straight line YL is not substantially displaced in the X-axis direction while being displaced in the Y-axis direction due to existence of the second support section 62. Consequently, no movement occurs at the central position CP of the light guide plate 3 in any direction.

When the light guide plate 3 is thermally expanded, the light guide plate 3 is displaced in an outward spreading manner about the central position CP. When the light guide plate 3 is cooled and thus contracted, the light guide plate 3 is displaced in a converging manner to the central position CP. Hence, displacement is smaller at a position closer to the central position CP. Consequently, the first support section 61 may be preferably disposed at the central position of the light guide plate 3 in the Y-axis direction, while the second support section 62 may be preferably disposed at the central position of the light guide plate 3 in the X-axis direction. This allows displacement of the light guide plate 3 as a whole with respect to the display section 1 to be reduced in a balanced manner.

[Exemplary Configuration of Scattering Region 31]

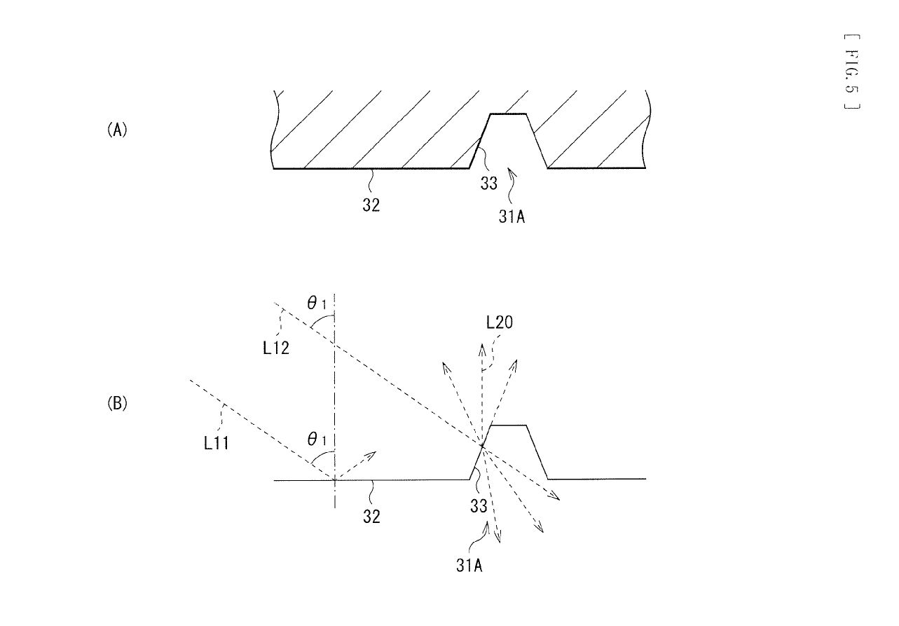

FIG. 5(A) illustrates a first exemplary configuration of the second internal reflection face 3B of the light guide plate 3. FIG. 5(B) schematically illustrates a reflecting state and a scattering state of light rays on the second internal reflection face 3B as the first exemplary configuration illustrated in FIG. 5(A). The first exemplary configuration is an exemplary configuration where the scattering regions 31 are formed as scattering regions 31A that are concave with respect to the total reflection regions 32. Such concave scattering regions 31A may be formed by, for example, sandblasting processing or laser processing. For example, the concave scattering regions 31A may be formed through mirror-finishing of a surface of the light guide plate 3 and then laser processing of portions corresponding to the concave scattering regions 31A. In the first exemplary configuration, first illumination light L11 from the first light source 2, the light L11 being incident at an angle θ1 that satisfies the total reflection condition, is internally totally reflected by the total reflection regions 32 on the second internal reflection face 3B. On the other hand, in the concave scattering regions 31A, even if first illumination light L12 enters the concave scattering regions 31A at the same incident angle θ1 as in the total reflection regions 32, part of the entered first illumination light L12 does not satisfy the total reflection condition on a concave side face portion 33. Thus, the first illumination light L12 is partially scatter-transmitted, and the rest is scatter-reflected. Part or all of such scatter-reflected light rays (scattered light rays L20) are emitted to the first internal reflection face 3A as illustrated in FIG. 1, as light rays that do not satisfy the total reflection condition.

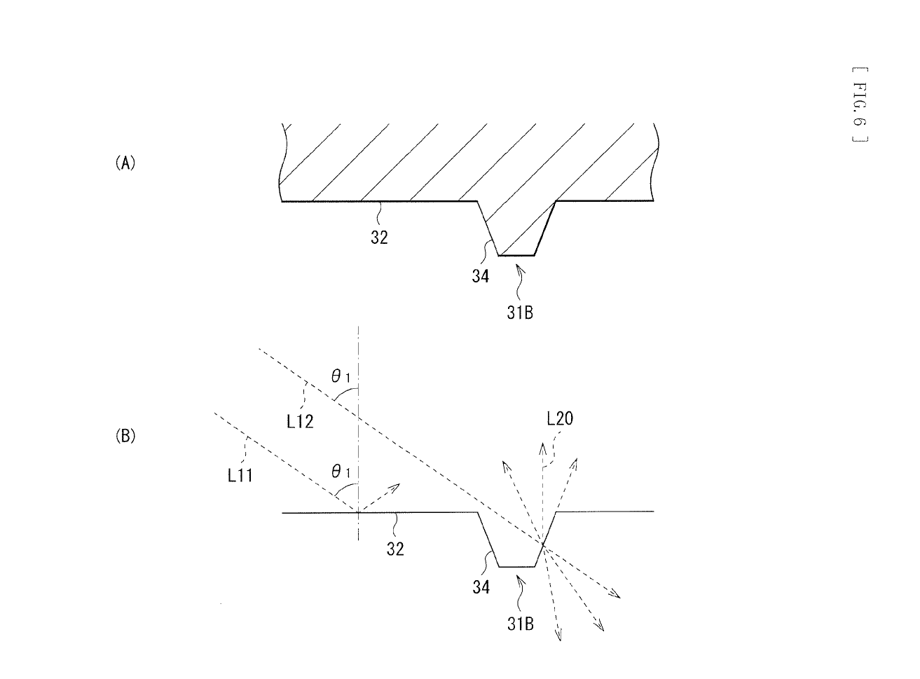

FIG. 6(A) illustrates a second exemplary configuration of the second internal reflection face 3B of the light guide plate 3. FIG. 6(B) schematically illustrates a reflecting state and a scattering state of light rays on the second internal reflection face 3B as the second exemplary configuration illustrated in FIG. 6(A). The second exemplary configuration is an exemplary configuration where the scattering regions 31 are formed as scattering regions 31B that are convex with respect to the total reflection regions 32. Such convex scattering regions 31B may be formed by, for example, processing of a surface of the light guide plate 3 with die molding. In such a case, the portions corresponding to the total reflection regions 32 are mirror-finished with the surface of a die. In the second exemplary configuration, the first illumination light L11 from the first light source 2, the light L11 being incident at an angle θ1 that satisfies the total reflection condition, is internally totally reflected by the total reflection region 32 on the second internal reflection face 3B. On the other hand, in the convex scattering region 31B, even if the first illumination light L12 enters the convex scattering region 31B at the same incident angle θ1 as in the total reflection region 32, part of the entered first illumination light L12 does not satisfy the total reflection condition on a convex side face portion 34. Thus, the first illumination light L12 is partially scatter-transmitted, and the rest is scatter-reflected. Part or all of such scatter-reflected light rays (scattered light rays L20) are emitted to the first internal reflection face 3A as illustrated in FIG. 1, as light rays that do not satisfy the total reflection condition.

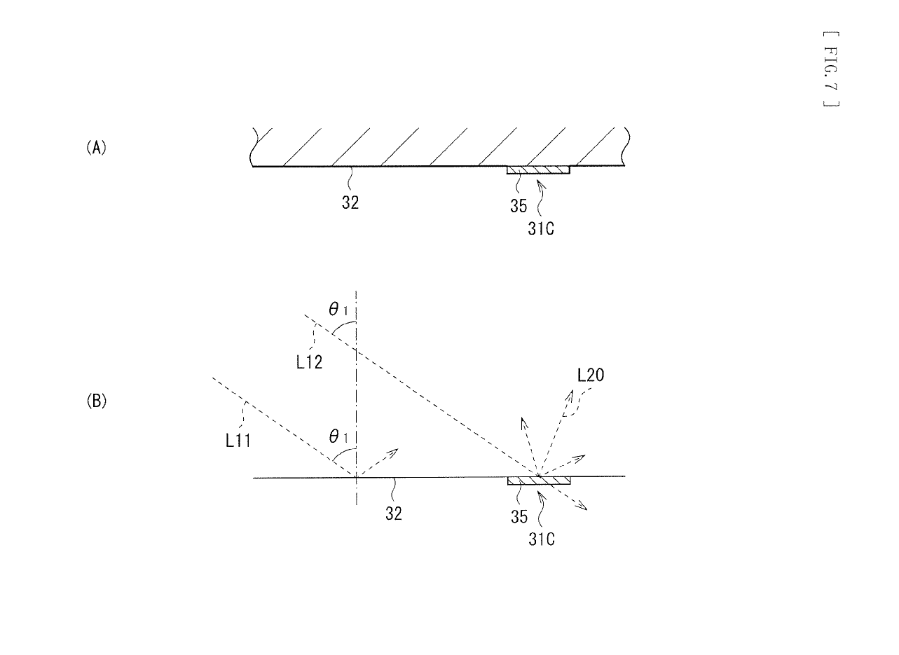

FIG. 7(A) illustrates a third exemplary configuration of the second internal reflection face 3B of the light guide plate 3. FIG. 7(B) schematically illustrates a reflecting state and a scattering state of light rays on the second internal reflection face 3B as the third exemplary configuration illustrated in FIG. 7(A). In the exemplary configurations shown in FIGS. 5(A) and 6(A), each scattering region 31 is formed through processing of the surface of the light guide plate 3 into a shape different from the total reflection region 32. On the other hand, in the exemplary configuration shown in FIG. 7(A), each scattering region 31C is formed by disposing a light scattering component 35, which is formed of a material different from that of the light guide plate 3, on the surface of the light guide plate 3 corresponding to the second internal reflection face 3B, instead of surface processing. In such a case, the scattering region 31C may be formed, for example, by forming a pattern of a white paint (for example, barium sulfate) as the light scattering component 35 on the surface of the light guide plate 3 by screen printing. In the case of the third exemplary configuration, the first illumination light L11 from the first light source 2, the light L11 being incident at the angle θ1 that satisfies the total reflection condition, is internally totally reflected by the total reflection region 32 on the second internal reflection face 3B. On the other hand, in the scattering region 31C on which the light scattering component 35 is disposed, even if the first illumination light L12 enters the scattering region 31C at the same incident angle θ1 as in the total reflection region 32, the entered first illumination light L12 is partially scatter-transmitted by the light scattering component 35, and the rest is scatter-reflected thereby. Part or all of such scatter-reflected light rays are emitted to the first internal reflection face 3A as light rays that do not satisfy the total reflection condition.

[Basic Operation of Display Unit]

In this display unit, in the case of performing display in the three-dimensional display mode, the display section 1 performs display based on three-dimensional image data, and the first light sources 2 and the second light source 7 are each controlled to be on (lit) or off (unlit) for three-dimensional display. Specifically, as illustrated in FIG. 1, the first light sources 2 are controlled to stay on (lit), and the second light source 7 is controlled to stay off (unlit). In this state, the first illumination light L1 from each first light source 2 is repeatedly and internally total-reflected between the first internal reflection face 3A and the second internal reflection face 3B in the light guide plate 3, thereby the first illumination light L1 is guided from a first side face, on which one of the first light sources 2 is disposed, to an opposite second side face, and is emitted through the second side face. In addition, part of the first illumination light L1 from the first light source 2 is scatter-reflected by the scattering regions 31 of the light guide plate 3 and thus transmitted by the first internal reflection face 3A of the light guide plate 3, and is emitted to the outside of the light guide plate 3. This allows the light guide plate itself to function as the parallax barrier. Specifically, the light guide plate 3 itself is allowed to equivalently function as the parallax barrier where the scattering regions 31 act as the openings (slit sections) and the total reflection regions 32 act as the light-shielding sections for the first illumination light L1 from the first light source 2. This results in display equivalent to three-dimensional display utilizing the parallax barrier system where the parallax barrier is disposed on the back side of the display section 1.

On the other hand, in the case of performing display in the two-dimensional display mode, the display section 1 performs display based on two-dimensional image data, and each of the first light sources 2 and the second light source 7 is controlled to be on (lit) or off (unlit) for two-dimensional display. Specifically, for example, as illustrated in FIG. 2, the first light sources 2 may be controlled to stay off (unlit), and the second light source 7 may be controlled to stay on (lit). In this case, the second illumination light L10 from the second light source 7 is transmitted by the total reflection regions 32 of the second internal reflection face 3B, and is thus emitted to the outside of the light guide plate 3 through substantially the entire first internal reflection face 3A as light rays that do not satisfy the total reflection condition. In other words, the light guide plate 3 functions as a planar light source similar to a typical backlight. This results in display equivalent to two-dimensional display utilizing the backlight system where a typical backlight is disposed on the back side of the display section 1.

It is to be noted that although the second illumination light L10 is emitted from substantially the entire surface of the light guide plate 3 even if only the second light source 7 is lit, the first light sources 2 may be also lit as illustrated in FIG. 3 as necessary. Consequently, for example, if luminance distribution is different between the portions corresponding to the scattering regions 31 and the portions corresponding to the total reflection regions 32 through lighting of only the second light source 7, the luminance distribution is allowed to be optimized over the entire surface through appropriate adjustment of a lighting state of the first light sources 2 (on/off control or adjustment of a lighting level). However, in the case of two-dimensional display, for example, if luminance is adequately corrected in the display section 1, only the second light source 7 may be lit.

[Correspondence Relationship between Assignment Pattern of Perspective Images and Arrangement Pattern of Scattering Regions 31]

In this display unit, the display section 1 displays a plurality of perspective images while assigning the perspective images to each pixel in a predetermined pattern for display in the three-dimensional display mode. The plurality of scattering regions 31 in the light guide plate 3 are provided in a predetermined arrangement pattern corresponding to the predetermined assignment pattern.

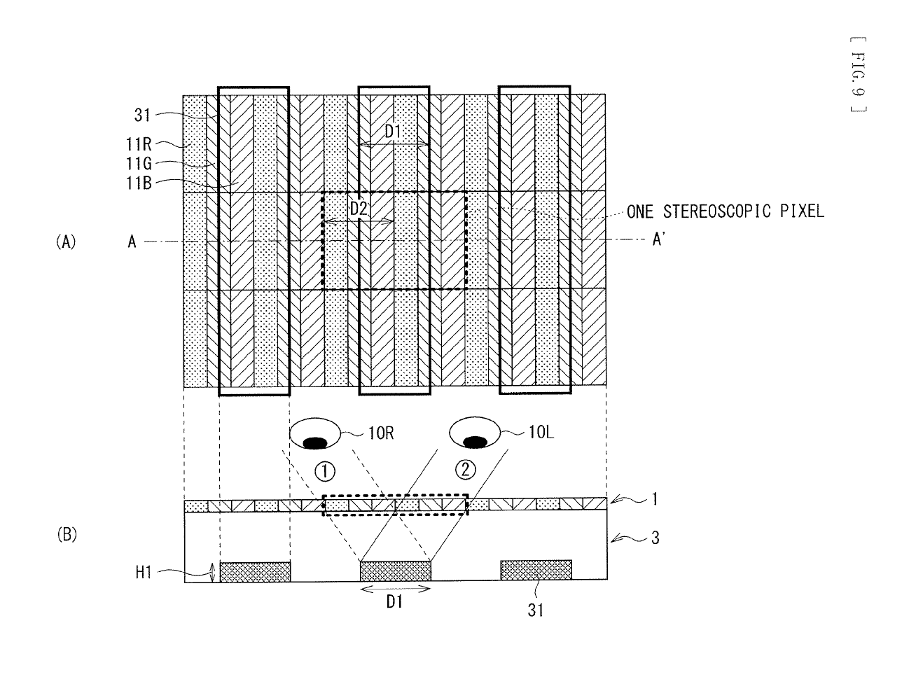

Specific examples of a correspondence relationship between the assignment pattern of perspective images and the arrangement pattern of the scattering regions 31 are now described. As illustrated in FIG. 8, a pixel structure of the display section 1 includes a plurality of pixels that each include a red pixel 11R, a green pixel 11G, and a blue pixel 11B, the plurality of pixels being arranged in a matrix in a first direction (vertical direction) and a second direction (horizontal direction). The pixels 11R, 11G, and 11B of respective three colors are arranged periodically and alternately in the horizontal direction, and the pixels 11R, 11G, or 11B of the same color are arranged in the vertical direction. In this pixel structure, in a state where a typical two-dimensional image is displayed on the display section 1 (the two-dimensional display mode), a combination of the horizontally continuous pixels 11R, 11G, and 11B of the respective three colors define one pixel for two-dimensional color display (one unit pixel for 2D color display). FIG. 9 illustrates the unit pixels for 2D color display by six in the horizontal direction and by three in the vertical direction.

FIG. 9(A) illustrates an example of a correspondence relationship between the assignment pattern of perspective images in assignment of two perspective images (first and second perspective images) to each pixel of the display section 1 and the arrangement pattern of the scattering regions 31 in the pixel structure illustrated in FIG. 8. FIG. 9(B) is an illustration equivalent to a section along a line A-A′ in FIG. 9(A). FIG. 9(B) schematically illustrates a separated state of the two perspective images. In this exemplary case, the one unit pixel for 2D color display is assigned as one pixel for display of one perspective image. In addition, the pixels are assigned such that the first and second perspective images are alternately displayed in a horizontal direction. Consequently, a horizontal combination of two unit pixels for 2D color display defines one unit image (one stereoscopic pixel) for three-dimensional display. As illustrated in FIG. 9(B), the first perspective image reaches only a right eye 10R of a viewer, and the second perspective image reaches only the right eye 10R of the viewer, so that stereoscopy is performed. In this exemplary case, a horizontal position of each scattering region 31 is so located as to be substantially the center of the one unit image for three-dimensional display.

A horizontal width D1 of each scattering region 31 has a size that has a predetermined relationship with a width D2 of one pixel for display of one perspective image. Specifically, the width D1 of the scattering region 31 may be preferably from 0.5 times to 1.5 times as large as the width D2. As the width D1 of the scattering region 31 increases, the amount of light scattered by the scattering region 31 increases, resulting in an increase in amount of light emitted from the light guide plate 3. As a result, luminance is allowed to be increased. However, if the width D1 of the scattering region 31 is more than 1.5 times as large as the width D2, light rays from a plurality of perspective images are undesirably mixedly viewed, or so-called crosstalk occurs. Contrarily, as the width D1 of the scattering region 31 decreases, the amount of light scattered by the scattering region 31 decreases, resulting in a decrease in amount of light emitted from the light guide plate 3. As a result, luminance decreases. If the width D1 of the scattering region 31 is less than 0.5 times as large as the width D2, luminance decreases excessively, undesirably leading to excessively dark image display.

[Effects]

As described above, according to the display unit of the present embodiment, the illuminating unit is configured such that the light guide plate 3 is supported by the first and second support sections 61 and 62. Consequently, even if the light guide plate 3 is thermally expanded (contracted), the light guide plate 3 as a whole is allowed to be prevented from moving from its initial position. Specifically, even if the light guide plate 3 is thermally expanded (contracted), the central position CP thereof is not relatively varied with respect to the second frame 6B, and displacement is smaller at a position closer to the central position CP. This is because a pair of first support sections 61 allow displacement of the light guide plate 3 in the X-axis direction while limiting the displacement in the Y-axis direction, and a pair of second support sections 62 allow displacement of the light guide plate 3 in the Y-axis direction while limiting the displacement in the X-axis direction.

Moreover, both the pair of first support sections 61 are located on the straight line XL, which prevents occurrence of distortion associated with displacement of the light guide plate 3 in the Y-axis direction. If the pair of first support sections 61 have a gap therebetween in the Y-axis direction, generation of expansion or contraction of a portion of the light guide plate 3 held therebetween causes stress in that portion. This is because the pair of first support sections 61 each limit displacement of the light guide plate 3 in the Y-axis direction.

In this way, according to the illuminating unit of the present embodiment, displacement of the light guide plate 3 during thermal expansion thereof is allowed to be reduced without hindering reduction in thickness of the illuminating unit. Consequently, according to the display unit incorporating the illuminating unit, a relative position between the light guide plate 3 and the display section 1 is allowed to be relatively accurately maintained while achieving reduction in thickness. As a result, it is possible to form an excellent stereoscopic image despite being of a thin type. In particular, when the central position CP is brought into correspondence with the central position of an effective display region of the display section 1, a stereoscopic image that is more comfortable for a viewer is promisingly achieved.

### Second Embodiment

A display unit according to a second embodiment of the present disclosure is now described. It is to be noted that substantially the same components as those of the display unit according to the first embodiment are designated by the same numerals, and description of them is appropriately omitted.

In the first embodiment, the illuminating unit is configured such that the guide direction of the guide section 61B of the first support section 61 corresponds to the X-axis direction, and the guide direction of the guide section 62B of the second support section 62 corresponds to the Y-axis direction. This is due to adoption of a configuration (so-called stripe barrier structure) for the light guide plate 3, in which the scattering regions 31 and the total reflection regions 32, the regions 31 and 32 forming a parallax barrier, are arranged in the X-axis direction while extending in the Y-axis direction.

[Exemplary Configuration of Illuminating Unit]

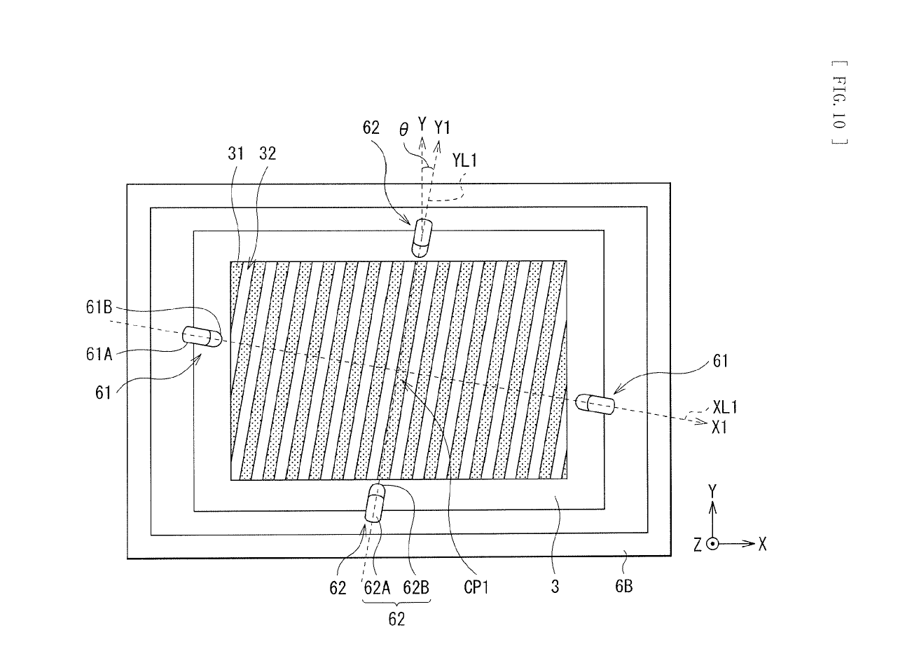

In the present embodiment, as illustrated in FIG. 10, a so-called oblique barrier structure is adopted for the light guide plate 3, and guide directions of the guide sections 61B and 62B are accordingly inclined with respect to the X-axis direction and the Y-axis direction, respectively. FIG. 10 is a plan diagram, which corresponds to FIG. 4(A), illustrating a relevant-part configuration of the illuminating unit of the display unit according to the present embodiment.

In the present embodiment, the scattering regions 31 and the total reflection regions 32 extend in a Y1 direction that is inclined by an angle θ from the Y-axis direction as the screen vertical direction. In conjunction with this, the pair of first support sections 61 are disposed on a straight line XL1 along an X1 direction orthogonal to the Y1 direction in a circumferential portion of the light guide plate 3. The guide section 61B of the first support section 61 has a shape adaptable to guiding the projection 61A along the X1 direction. On the other hand, the pair of second support section 62 are disposed on a straight line YL1 along the Y1 direction in the circumferential portion of the light guide plate 3. The guide section 62B of the second support section 62 has a shape adaptable to guiding the projection 62A along the Y1 direction.

[Effects]

In the present embodiment, for example, when the light guide plate 3 is heated and cooled and thereby expanded and contracted, each portion of the light guide plate 3 is displaced with respect to a position (central position) CP1 at which the straight line XL1 intersects with the straight line YL1. In this case, the central position CP1 of the light guide plate 3 does not move in any direction. Consequently, the present embodiment also provides effects similar to those of the first embodiment. Moreover, in the present embodiment, the first and second support sections 61 and 62 are disposed in accordance with the direction of the parallax barrier formed in the light guide plate 3. As a result, variations (imbalances) of displacement of a relative position between a corresponding display pixel and the parallax barrier is allowed to be sufficiently reduced. Consequently, a stereoscopic image having more excellent visibility is allowed to be formed.

### APPLICATION EXAMPLES

Application examples of any of the above-described display units are now described.

The display unit according to the present technology is applicable to electronic apparatuses for various applications without particular limitation to a type of the electronic apparatus. For example, the display unit may be mountable in the following electronic apparatuses. However, the following electronic apparatuses are each merely shown as an example, and therefore configurations thereof may be appropriately modified.

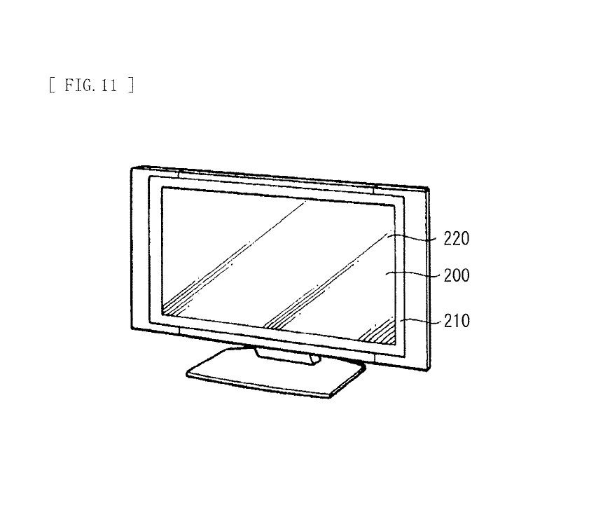

FIG. 11 illustrates an appearance configuration of a television unit. The television unit may have, for example, an image display screen section 200 as a display unit. The image display screen section 200 includes a front panel 210 and a filter glass 220.

The display unit of the present technology is usable not only for the television unit illustrated in FIG. 11 but also for an image display section of, for example, a tablet personal computer (PC), a notebook PC, a mobile phone, a digital still camera, a video camcorder, and a car navigation system.

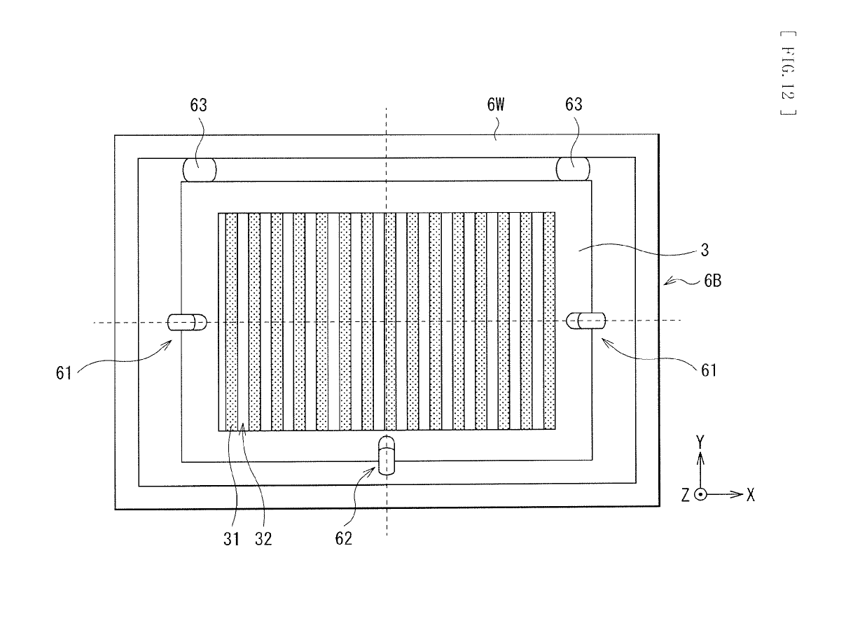

Although the present technology has been described with some example embodiments hereinbefore, the technology is not limited thereto, and various modifications or alterations thereof may be made. For example, although two first support sections 61 and two second support sections 62 are provided in the above-described embodiments, etc., the technology is not limited thereto. For example, as illustrated in FIG. 12, only one of the second support sections 62 may be provided. The guide section 62B of the one second support section 62 may guide the projection 62A in the Y-axis direction, for example. In such a case, the light guide plate 3 is also displaced in the X-axis direction with respect to the central position CP due to existence of the one second support section 62, so that displacement balance between a right side and a left side of the straight line YL is ensured. Moreover, for example, when the Y-axis direction is assumed as a vertical direction, the weight of the light guide plate 3 itself is allowed to be supported by the pair of first support sections 61 in a balanced manner. In such a case, the light guide plate 3 is displaced in the Y-axis direction with respect to the straight line XL in a vertically balanced manner. It is to be noted that, for example, a biasing member 63 (such as an elastic body or a spring), which biases the light guide plate 3 downward (in a −Y direction), may be provided in place of the second support section 62 to suppress backlash of the light guide plate 3. Although FIG. 12 shows an example where two biasing members 63 configured of an elastic body are disposed between the light guide plate 3 and a wall section 6W of the second frame 6B, disposed positions and the number of the biasing members 63 are not limited thereto.

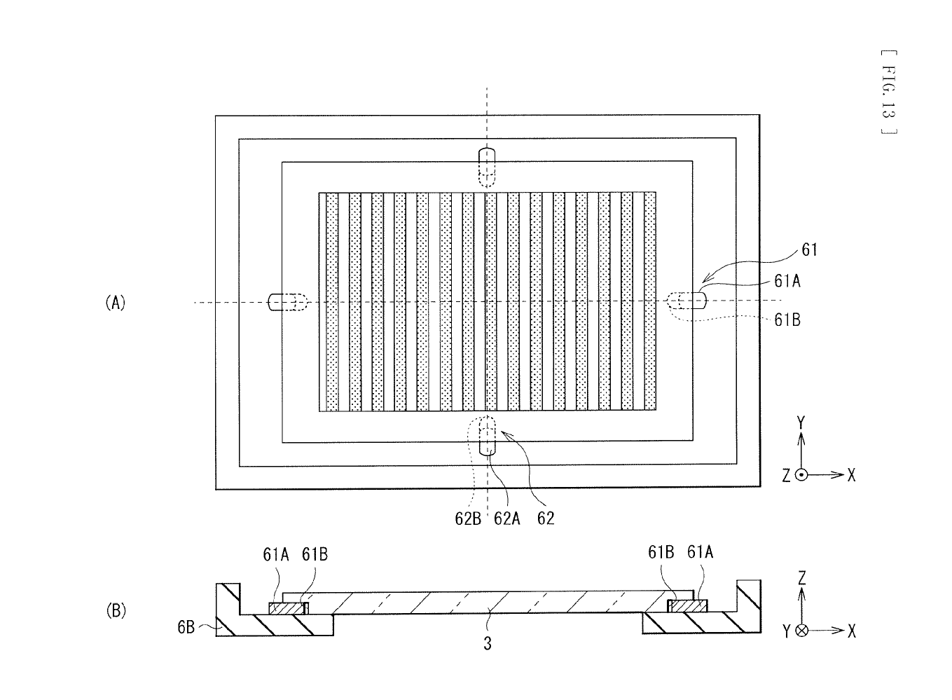

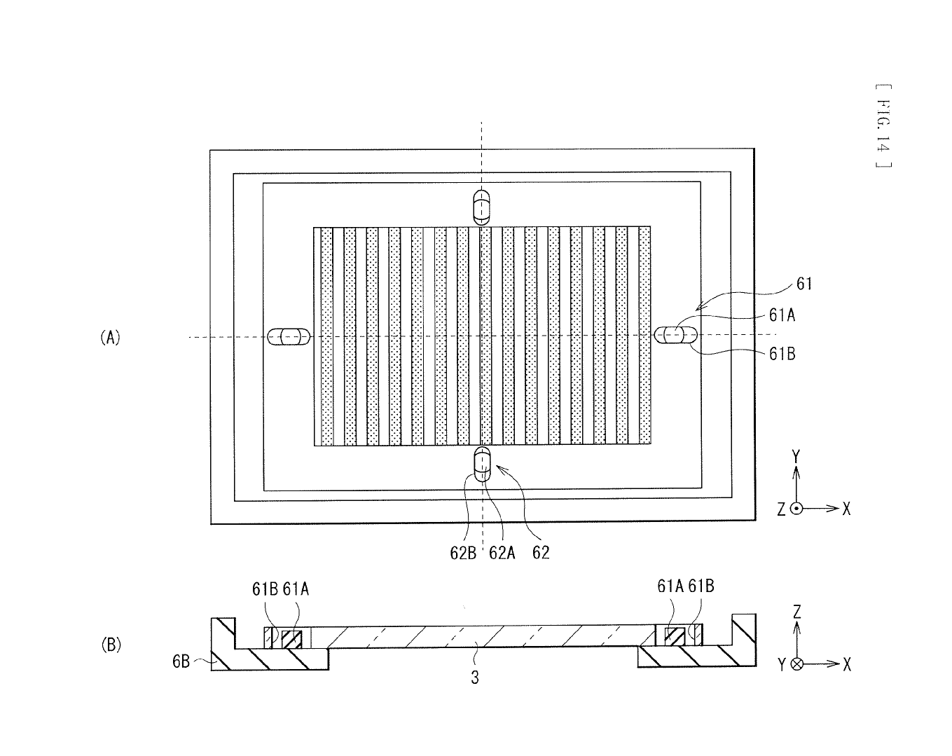

Although the guide sections 61B and 62B of the second support sections 61 and 62 are each formed as a notch in the above-described embodiments, this is not limitative. For example, as illustrated in FIGS. 13 and 14, the guide sections 61B and 62B may be formed as grooves or openings extending in the second and first directions, respectively. Moreover, although the projections 61A and 62A of the first and second support sections 61 and 62 are vertically provided on the second frame 6B, the projections 61A and 62A may be provided on the light guide plate 3. In such a case, the guide sections 61B and 62B may be provided on the second frame 6B.

The present technology may have the following configurations.

(1) An illuminating unit for a display unit, the illuminating unit including:
a light guide plate extending in a plane that includes a first direction and a second direction intersecting with each other;
a substrate supporting the light guide plate; and
first and second support sections provided in part of the light guide plate and part of the substrate,
wherein the first support section allows displacement of the light guide plate in the second direction while limiting displacement of the light guide plate in the first direction, and
the second support section allows displacement of the light guide plate in the first direction while limiting displacement of the light guide plate in the second direction.

(2) The illuminating unit according to (1), wherein the first support section includes a plurality of first support sections that are disposed on a same straight line extending in the second direction.

(3) The illuminating unit according to (2), wherein the second support section includes a plurality of second support sections that are disposed on a same straight line extending in the first direction.

(4) The illuminating unit according to any one of (1) to (3), wherein
the first support section is disposed at a central position of the light guide plate in the first direction, and
the second support section is disposed at a central position of the light guide plate in the second direction.

(5) The illuminating unit according to any one of (1) to (4), wherein each of the first and second support sections includes:
a projection provided on one of the light guide plate and the substrate; and
a guide section that is provided on the other of the light guide plate and the substrate, and guides the projection in one of the second direction and the first direction.

(6) The illuminating unit according to (5), wherein
the guide section of the first support section is one of a groove, a notch, and an opening extending in the second direction, and
the guide section of the second support section is one of a groove, a notch, and an opening extending in the first direction.

(7) The illuminating unit according to any one of (1) to (6), wherein the first and second support sections are located in a circumferential portion of the light guide plate.

(8) The illuminating unit according to any one of (1) to (7), further including a light source configured to apply illumination light into the light guide plate,
wherein the light guide plate has a first internal reflection face and a second internal reflection face opposed to each other, and
wherein one or both of the first and second internal reflection faces has a plurality of scattering regions that allow the illumination light from the light source to be scattered and emitted to outside of the light guide plate.

(9) A display unit provided with an illuminating unit and a display section configured to perform image display using light from the illuminating unit, the illuminating unit including:
a light guide plate extending in a plane that includes a first direction and a second direction intersecting with each other;
a substrate supporting the light guide plate; and
first and second support sections provided in part of the light guide plate and part of the substrate,
wherein the first support section allows displacement of the light guide plate in the second direction while limiting displacement of the light guide plate in the first direction, and
the second support section allows displacement of the light guide plate in the first direction while limiting displacement of the light guide plate in the second direction.

(10) The display unit according to (9), wherein the substrate also supports the display section.

(11) An electronic apparatus provided with a display unit, the display unit being provided with an illuminating unit and a display section configured to perform image display using light from the illuminating unit, the illuminating unit including:
a light guide plate extending in a plane that includes a first direction and a second direction intersecting with each other;
a substrate supporting the light guide plate; and
first and second support sections provided in part of the light guide plate and part of the substrate,
wherein the first support section allows displacement of the light guide plate in the second direction while limiting displacement of the light guide plate in the first direction, and
the second support section allows displacement of the light guide plate in the first direction while limiting displacement of the light guide plate in the second direction.

This application claims the benefit of priority under Japanese Priority Patent Application JP 2011-244826 filed in the Japan Patent Office on Nov. 8, 2011, the entire content of which is incorporated herein by reference.

It should be understood by those skilled in the art that various modifications, combinations, sub-combinations and alterations may occur depending on design requirements and other factors insofar as they are within the scope of the appended claims or the equivalents thereof.

1. An illuminating unit for a display unit, the illuminating unit comprising:
a light guide plate extending in a plane that includes a first direction and a second direction intersecting with each other;
a substrate supporting the light guide plate; and
first and second support sections provided in part of the light guide plate and part of the substrate,
wherein the first support section allows displacement of the light guide plate in the second direction while limiting displacement of the light guide plate in the first direction, and
the second support section allows displacement of the light guide plate in the first direction while limiting displacement of the light guide plate in the second direction.

2. The illuminating unit according to claim 1, wherein the first support section comprises a plurality of first support sections that are disposed on a same straight line extending in the second direction.

3. The illuminating unit according to claim 2, wherein the second support section comprises a plurality of second support sections that are disposed on a same straight line extending in the first direction.

4. The illuminating unit according to claim 1, wherein
the first support section is disposed at a central position of the light guide plate in the first direction, and
the second support section is disposed at a central position of the light guide plate in the second direction.

5. The illuminating unit according to claim 1, wherein each of the first and second support sections includes:
a projection provided on one of the light guide plate and the substrate; and
a guide section that is provided on the other of the light guide plate and the substrate, and guides the projection in one of the second direction and the first direction.

6. The illuminating unit according to claim 5, wherein
the guide section of the first support section is one of a groove, a notch, and an opening extending in the second direction, and
the guide section of the second support section is one of a groove, a notch, and an opening extending in the first direction.

7. The illuminating unit according to claim 1, wherein the first and second support sections are located in a circumferential portion of the light guide plate.

8. The illuminating unit according to claim 1, further comprising a light source configured to apply illumination light into the light guide plate,
wherein the light guide plate has a first internal reflection face and a second internal reflection face opposed to each other, and
wherein one or both of the first and second internal reflection faces has a plurality of scattering regions that allow the illumination light from the light source to be scattered and emitted to outside of the light guide plate.

9. A display unit provided with an illuminating unit and a display section configured to perform image display using light from the illuminating unit, the illuminating unit comprising:
a light guide plate extending in a plane that includes a first direction and a second direction intersecting with each other;
a substrate supporting the light guide plate; and
first and second support sections provided in part of the light guide plate and part of the substrate,
wherein the first support section allows displacement of the light guide plate in the second direction while limiting displacement of the light guide plate in the first direction, and
the second support section allows displacement of the light guide plate in the first direction while limiting displacement of the light guide plate in the second direction.

10. The display unit according to claim 9, wherein the substrate also supports the display section.

11. An electronic apparatus provided with a display unit, the display unit being provided with an illuminating unit and a display section configured to perform image display using light from the illuminating unit, the illuminating unit comprising:
a light guide plate extending in a plane that includes a first direction and a second direction intersecting with each other;
a substrate supporting the light guide plate; and
first and second support sections provided in part of the light guide plate and part of the substrate,
wherein the first support section allows displacement of the light guide plate in the second direction while limiting displacement of the light guide plate in the first direction, and
the second support section allows displacement of the light guide plate in the first direction while limiting displacement of the light guide plate in the second direction.
